(19) United States
(12) Patent Application Publication
(10) Pub. No.: US 2007/0185786 A1
(43) Pub. Date: Aug. 9, 2007

(54) Systems and methods for inventory allocation in mobile logistics networks

(75) Inventors: Markus Ettl, Yorktown Heights, NY (US); Pu Huang, Yorktown Heights, NY (US); Young M. Lee, Old Westbury, NY (US); Karthik Sourirajan, West Lafayette, IN (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/347,200

(22) Filed: Feb. 6, 2006

(51) Int. Cl. G06Q 10/00

(52) U.S. Cl. 705/28

(57) ABSTRACT

A system and method for optimizing an inventory placement policy for parts within an organization comprising a plurality of mobile entities allocates at least one of said parts to one of the plurality of mobile entities according to a demand within the plurality of mobile entities, and generates an output.

This invention was made with Government support under Contract No.: MDA972-01-C-0025 awarded by the Defense Advanced Research Projects Agency (DARPA). The Government has certain rights in this invention.

### BACKGROUND OF THE INVENTION

1. Field of the Invention

The present invention generally relates to an inventory allocation system and method. In particular, the present invention relates to an inventory allocation system and method for allocating parts within an organization having mobile entities.

2. Description of the Related Art

Conventional inventory allocation systems have been outpaced by the extreme maneuverability and changing demands and the mobility of entities within an organization.

Conventional inventory allocation systems may work acceptably in environments of relatively predictable demand. However, these systems fail to adequately allocate items within organizations where the structure of the organization may change rapidly, the entities within the organization may be highly mobile, and where the demand for these items may be highly variable.

For example, today's military logistics systems have not been able to adequately address these issues which have resulted in low operational availability rates. These conventional military logistics systems may have been able to satisfy the demands of peacetime garrison operations or traditional highly planned force-on-force operations. However, the conventional inventory allocation systems break down in situations of rapid force structure changes, extremely mobile forces, and the highly variable demand that is characteristic of, for example, today's military organizations.

Conventional inventory allocation systems and methods are not capable of allocating parts throughout an organization having mobile entities.

Further, conventional inventory allocation systems and methods are not capable of allocating parts throughout an organization which is capable of multiple sourcing.

In particular, conventional inventory allocation systems and methods are not capable of allocating parts throughout an organization, which is capable of rapidly and dynamically establishing and dis-establishing sourcing relationships and which is capable of selecting suppliers on-the-fly.

Further, these conventional allocation systems have not been able to adequately allocate parts within an organization which includes entities which are capable of supplying parts to other entities within the organization.

### SUMMARY OF THE INVENTION

In view of the foregoing and other exemplary problems, drawbacks, and disadvantages of the conventional methods and structures, an exemplary feature of the present invention is to provide a method and structure in which allocation of inventory within an organization with a plurality of mobile entities is optimized.

A first exemplary aspect of the present invention includes a system for optimizing an inventory placement policy for parts within an organization comprising a plurality of mobile entities. The system includes an instant inventory allocator that allocates at least one of the parts to one of the plurality of mobile entities according to a demand within the plurality of mobile entities, and an inventory allocation output device that generates an output that includes the inventory allocated by the instant inventory allocator.

An exemplary embodiment of the present invention may further, optionally, include a response time minimizing allocator that allocates at least one other of the parts to one of the plurality of mobile entities to minimize a response time between entities. The inventory allocator and response time minimizing allocator may be invoked sequentially or independently, based on the state of the logistics network in accordance with an exemplary embodiment of the present invention.

A second exemplary aspect of the present invention includes a computer-implemented method that determines an inventory allocation policy for parts within an organization comprising a plurality of mobile entities. The method includes allocating at least one of the parts to one of the plurality of mobile entities according to a demand within the plurality of mobile entities, and generating an output that is based upon the allocating.

An exemplary embodiment of the present invention provides a method and system for inventory allocation within organizations, which have mobile entities.

An exemplary embodiment of the present invention may use up-to-date information on available inventory, supply points, and advance demand signals (e.g., demand forecasts) to generate an inventory allocation.

An exemplary embodiment of the present invention may exploit cross-leveling opportunities, which might entail getting multiple parts from different, rapidly changing locations to satisfy a demand. For example, the present invention may optimize inventory allocation taking into account the ability of the entities within an organization to supply each other as opposed to a single, centralized organizational level supply. This ability may be called “cross-leveling.”

An exemplary embodiment of the present invention may account for unit movements within a planning horizon. In other words, the present invention may be used for providing an inventory allocation plan which is applicable over a given period of time (i.e. a planning horizon).

An exemplary embodiment of the present invention may deal effectively with temporal supply shortfalls (such as delayed deliveries) or more serious supply shortfalls that could lead to degradation of capability.

An exemplary embodiment of the present invention may provide a new method for inventory placement and distribution in support of tactical ground or aerial logistics control.

An exemplary embodiment of the present invention may lead to dramatic increases of operational availability, unit readiness, and greater agility to effectively support unanticipated and rapidly changing demands.

An exemplary embodiment of the present invention may determine an inventory allocation which is an optimized set of pre-positioned levels of on-hand supply parts (such, as, for example, service parts, production parts, non-discrete parts, such as, for example, fuel, water, and the like) to mobile entities within an organization to ensure that the operational capability of the organization is optimized

In contrast to conventional inventory systems and methods, an exemplary embodiment of the present invention can deal with mobile entities (such as, for example, mobile supply points and mobile demand points) that may change locations during a period of time that is covered by a planning horizon.

Furthermore, an exemplary embodiment of the present invention might not rely upon static sourcing relationships to allocate inventory. Instead, this embodiment may manage the allocation of inventory to each entity dynamically by exploiting opportunities for multiple sourcing and cross-leveling of supply.

An exemplary embodiment of the present invention may determine an inventory allocation for supply parts to entities within an organization that may optimize one or more “enterprise-wide” (e.g., “organization-wide”) performance metrics. Supply parts may include, for example, service parts, production parts, non-discrete parts (e.g., fuel, water, etc.), and the like. Enterprise-wide performance metrics may include, for example, operational availability, customer wait time, demand satisfaction, off-the-shelf fill rates, and the like.

An exemplary embodiment of the present invention may manage the replenishment of each entity within an organization efficiently by exploiting opportunities for multiple sourcing and cross-leveling of supply.

An exemplary embodiment of the present invention may use advance demand information to pro-actively allocate supply parts so that future demand can be served faster.

An exemplary embodiment of the present invention may take as input a forecast of available inventory, a forecast of equipment breakages, and the future positions of the entities (e.g., logistics points). This embodiment may produce as output an inventory allocation plan for distributing items (such as, for example, spare parts and the like) among the organization and each entity within the organization for a period of time.

In determining the allocation of the items to each entity and the number of items allocated to each entity, an exemplary embodiment of the present invention may consider restrictions on the storage capacity for each entity within the organization as well as the relative priorities between the entities in the organization.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary inventory allocation system 100 in accordance with the present invention;

FIG. 2 illustrates a signal bearing medium 200 (e.g., storage medium) for storing a program of a method according to an exemplary embodiment of the present invention;

FIG. 3 illustrates an exemplary organization 300 for which an exemplary embodiment of the present invention may generate an inventory allocation;

FIG. 4 is a flowchart 400 that outlines one exemplary method for allocating inventory in accordance with the invention;

FIG. 5 is a block diagram of one exemplary embodiment of an inventory allocation system 500 in accordance with the present invention; and

FIG. 6 is an illustration of transit times between entities within an organization 600 for which an exemplary embodiment of the present invention may generate an inventory allocation.

### DETAILED DESCRIPTION OF EXEMPLARY EMBODIMENTS OF THE INVENTION

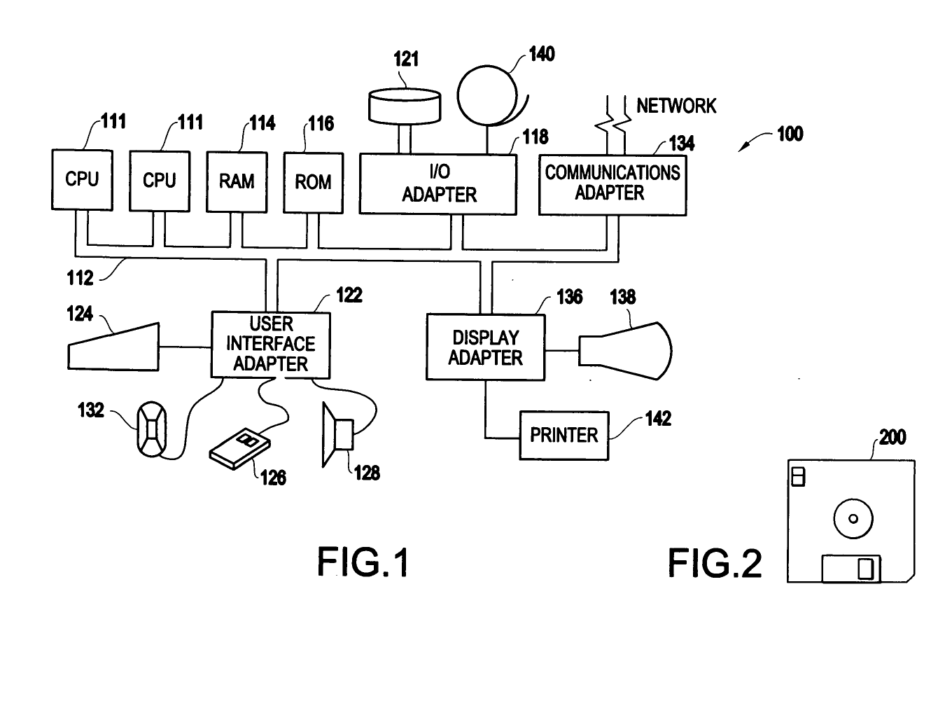

Referring now to the drawings, and more particularly to FIGS. 1-6, there are shown exemplary embodiments of the methods and systems of the present invention.

FIG. 1 illustrates a typical hardware configuration of an information handling/computer system for use with the invention and which preferably has at least one processor or central processing unit (CPU) 111.

The CPUs 111 are interconnected via a system bus 112 to a random access memory (RAM) 114, read-only memory (ROM) 116, input/output (I/O) adapter 118 (for connecting peripheral devices such as disk units 121 and tape drives 140 to the bus 112), a user interface adapter 122 (for connecting a keyboard 124, a mouse 126, a speaker 128, a microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or a printer 142.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 111, as represented by the fast-access storage for example. Alternatively, the instructions may be contained in another signal-bearing media, such as a magnetic data storage diskette 200 (FIG. 2), directly or indirectly accessible by the CPU 111.

Whether contained in the diskette 200, the computer/CPU 111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as, for example, “C”, etc.

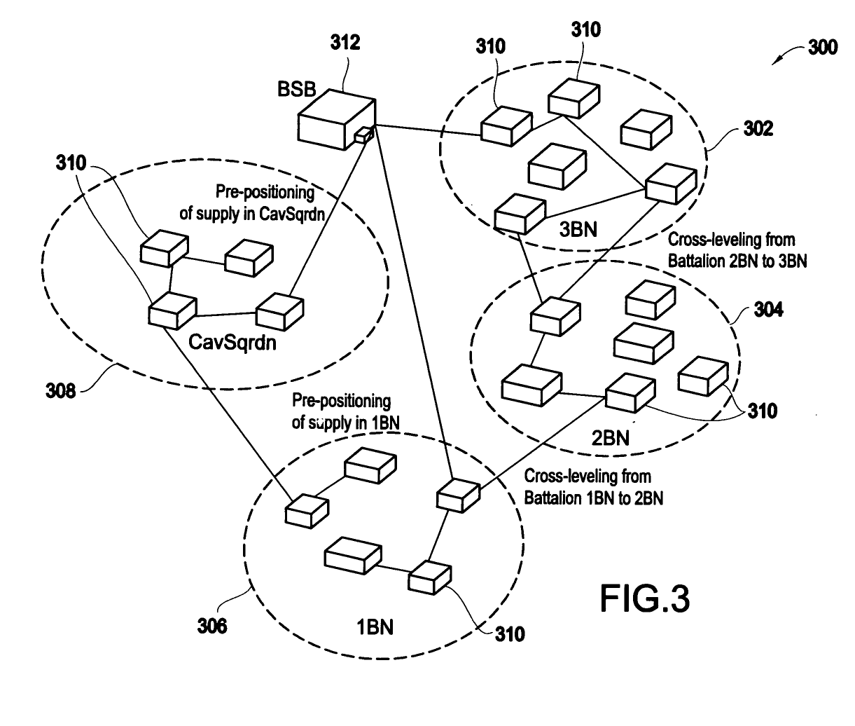

FIG. 3 illustrates an example of an organization 300 for which an exemplary embodiment of the present invention may generate an inventory allocation plan. This exemplary organization 300 is a military brigade that includes four battalions 302, 304, 306, and 308. Each battalion, 302, 304, 306, and 308, further includes entities which, in this example, include companies 310. This brigade 300 also includes a mobile supply depot 312 (such as, for example, a Brigade Support Battalion (BSB)).

An exemplary embodiment of the present invention may overcome technical challenges in solving the inventory allocation problem. These challenges include mobile logistics points that may change their actual positions within the planning horizon and the ability of each entity in the organization to be replenished from multiple entities. This is called “cross-leveling.”

For example, the brigade 300 may include battalions 302, 304, 306, and 308, which include companies 310 which are mobile and which may rapidly change their locations.

An exemplary embodiment of the present invention may optimize the intra-brigade distribution and delivery of repair parts within a brigade to achieve the best possible mission capability. This “mission capability” is one example of an enterprise-wide performance metric, which the invention may optimize. A standard performance metric that measures the mission capability of a brigade is Operational Availability, A_{O}.

In a brigade, Operational Availability may be defined, for example, as the fraction of mission-capable combat vehicles over the total number of vehicles in the brigade. For example, if a battalion comprises sixty combat vehicles and three vehicles are waiting for repair parts or are undergoing repair, the Operational Availability, A_{O} is:
A_{O}=57/60=95%. (1)

In military practice, A_{O} is measured separately for different classes of combat vehicles and military organizational structures, and may take into account priorities, before it is rolled up to a battalion-level and brigade-level Operational Availability.

The Operational Availability is directly related to another enterprise-wide performance metric called Customer Wait Time, CWT. Customer Wait Time may be defined as the total elapsed time between issuance of a customer order and satisfaction of that order, or in this context the total elapsed time between part breakage and the delivery of the repair part to a combat vehicle. Minimizing Customer Wait Time is somewhat analogous to maximizing Operational Availability; in other words, the lower the Customer Wait Time, the higher the Operational Availability. Therefore, an exemplary embodiment of the present invention may determine an inventory allocation for placement of repair parts with the aim of satisfying the objective of minimizing an expected, priority-weighted, Customer Wait Time (CWT).

The Customer Wait Time, CWT may defined as the expected time between part breakage and repair part availability as represented by the following equation:
CWT=T₁−T₀ (2)
Where: T₀ denotes the expected time of a part breakage; and

T₁ denotes the time at which the replacement part is expected to be delivered.

An exemplary embodiment of the present invention may base the inventory allocation upon any number of different types of input data. For example, an exemplary embodiment which optimizes inventory allocation for a military brigade may receive, as input data, a list of repair parts, indexed by p (part); a list of military units, indexed by c (companies) or b (battalions); and the relative importance (or priority) for each military unit, w_{c} for companies and w_{b} for battalions.

The relative importance, w, may be a non-negative weight representing an entity's priority relative to other entities within the organization. The weights may be derived from, for example, scenario information in an operational plan of a brigade. Further, a larger priority weight for an entity may mean a higher priority for that entity.

This exemplary embodiment of the present invention may also receive, as input data, expected locations for each military unit over a time period; and an expected transit time between any two military units by time period. The future positions of military units may, for example, be derived from scenario information in an operational plan. The transit times may be computed using a shortest-path algorithm that may, for example, account for the state of a road network and future expected locations of the military unit.

This exemplary embodiment of the present invention may also receive, as input data, the storage capacity of repair part p at company c, C_{pc}; the storage capacity of repair part p at battalion b, C_{pb}; and a demand statement of the number of repair parts p needed at company c, D_{pc}, during the planning horizon to fulfill current and future breakages.

The demand statement may include a backlogged demand that has not been satisfied up to this time, and future demand that is based upon a forecast of future breakages.

Future breakages might not be provided as an explicit input. Instead, an exemplary embodiment of the present invention may infer estimates from historical data and an authorized stocking list for repair parts, in conjunction with an operational plan and, in particular, an anticipated operational tempo for the military units.

This exemplary embodiment of the present invention may also receive, as input data, information regarding inventory that may be in transit to the brigade and that may be expected to be received at a brigade supply depot during the planning horizon; the inventory on-hand that is available for allocation; and the inventory in-transit that is available for allocation. The inventory in transit to the brigade may include all of the repair parts that are stored at companies within the battalion or at a battalion level supply depot. The inventory on-hand that is available for allocation may include all repair parts that are stored at companies or at a battalion level supply depot. The inventory in-transit that is available for allocation may include all repair parts stored on trucks and with combat repair teams.

Based upon at least one of the above-identified data input, this exemplary embodiment of the present invention may provide as output an optimal inventory allocation for each part p, company c and battalion b, that minimizes the expected, priority-weighted, Customer Wait Time.

In this exemplary embodiment most of the above input and output variables may be defined along three dimensions: a military unit c (company) or b (battalion), a part type p, and a time period t.

In a mathematically rigorous exemplary embodiment of the present invention, each variable may be indexed over the three indices (c,p,t). However, as understood by those of ordinary skill in the art in view of the present disclosure, to reduce the number of symbols, and, thus the computational resources it may not be necessary to do so and, therefore, and the time index t may be suppressed.

Typically in a military brigade, some repair parts are replenished-to-order or are kept centrally at a brigade level supply depot. For such parts, an exemplary embodiment of the present invention might not create an inventory allocation plan.

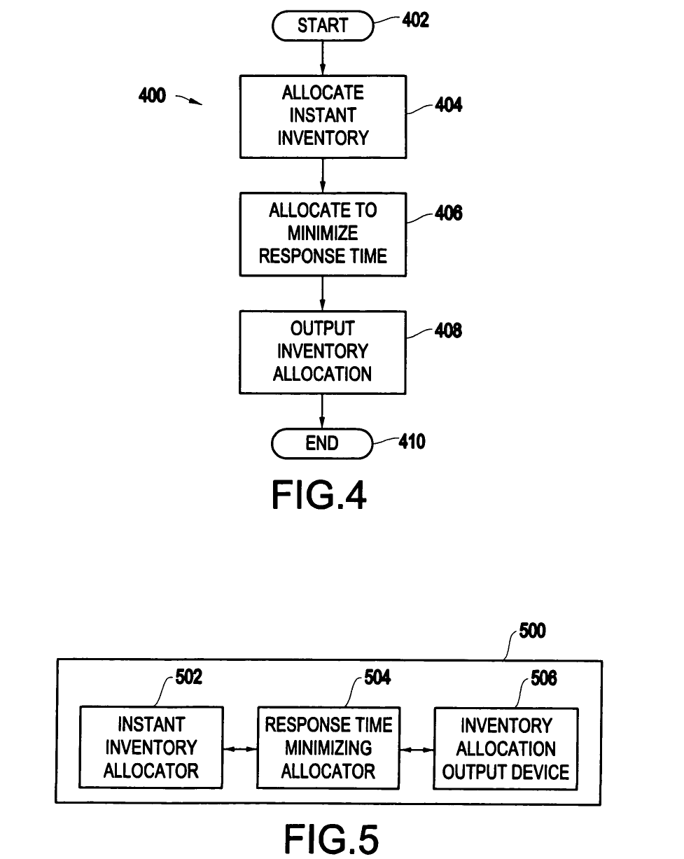

FIG. 4 illustrates a flowchart 400 in accordance with an exemplary embodiment of the present invention. The flowchart 400 starts at step 402 and continues to step 404. In step 404, the exemplary embodiment allocates inventory to provide for instantaneous demand and, for example, this step is performed by an instant inventory allocator. The flowchart continues to step 406, where the exemplary embodiment allocates inventory to minimize response time between entities and, for example, this step is performed by a response time minimizing allocator, and continues to step 408. In step 408, the exemplary embodiment outputs the inventory allocation and continues to step 410 where the method ends.

FIG. 5 is a block diagram that illustrates an exemplary embodiment of an inventory allocation system 500 in accordance with the invention. The inventory allocation system 500 includes an instant inventory allocator 502, a response time minimizing allocator 504, and an inventory allocation output device 506. This exemplary embodiment may execute the method of the flowchart of FIG. 4.

An exemplary embodiment of the present invention may proceed by allocating inventory to instantaneously respond to breakages, to allocate constrained repair parts and extra inventory, and to generate an inventory allocation plan.

The allocation of inventory to instantaneously respond to breakages may maximize the fraction of breakages that can be served immediately from pre-positioned repair parts inventory at companies, taking into account the priorities of the various military units.

The parts may be allocated hierarchically, first to battalions and then to companies, using, for example, a pro-rata scheme. One goal when allocating spare parts within a brigade may be to cover the breakages that have been forecasted for all companies within each battalion of a brigade. An exemplary embodiment of the present invention may do this based upon the following equation:

$${X}_{pb} := min ( {C}_{pb} , \frac{{\sum }_{c ∈ b} {w}_{c} {D}_{pc}}{{\sum }_{c ∈ B} {w}_{c} {D}_{pc}} {A}_{p} ) \qquad ( 3 )$$

where:

X_{pb} is the amount of inventory of a part p allocated to a battalion b;

C_{pb} is the storage capacity for part p at battalion b;

c corresponds to a company;

b corresponds to a battalion;

B denotes the set of all battalions in a brigade;

w_{c} is relative priority of a company c;

D_{pc} is the breakage forecast for a part type p at a company c; and

Aₚ is the expected amount of supply of a part type p available in the brigade.

The expected amount of supply that is available in the brigade may be determined using the following equation:

$${A}_{p} = {W}_{p} + {\sum }_{c ∈ B} {I}_{pc} - {\sum }_{c ∈ B} {B}_{pc} \qquad ( 4 )$$

Where:

Wₚ is the expected on-hand inventory for part type p;

I_{pc} is the expected inflow of part type p in company c; and

B_{pc} is the expected outflow of a part type p for company c.

Having thus allocated parts to a battalion, b, an exemplary embodiment of the present invention further allocates items to each company, c in the batallion, using a similar pro-ration scheme as follows:

$${X}_{pc} := \{ {C}_{pc} , \frac{{w}_{c} {D}_{pc}}{{\sum }_{c ∈ b} {w}_{c} {D}_{pc}} Xpb \} \qquad ( 5 )$$

Where:

X_{pb} corresponds to the amount of part type p allocated to battalion b.

An exemplary embodiment of the present invention may also denote the weighted fulfillment ratio for a unit u, uε{c, b} as:

$${f}_{u} = \frac{{X}_{u}}{{w}_{u} {D}_{u}} \qquad ( 6 )$$

Where:

Xᵤ is the inventory allocated to unit u;

wᵤ is the relative priority of unit u; and

Dᵤ is the demand from unit u.

The allocation scheme through equations (4) and (5) balances the fulfillment ratios of all battalions and companies while satisfying the capacity constraints of the battalion capacity, C_{pb} and of each company's capacity, C_{pc}. This maximizes the number of expected future breakages that can be satisfied instantaneously while retaining a balanced allocation of repair parts within the brigade.

An exemplary embodiment of the present invention may next allocate parts to companies where future breakages may happen. Thus, if a breakage does happen, it can be serviced almost instantaneously from on-hand supply, which means that the customer wait time, CWT, is zero or almost zero. The more repair parts are allocated to instantaneously respond to breakages, the more likely it is that broken equipment will have a repair part delivered from within its company.

This exemplary embodiment of the present invention allocates any remaining supply in a manner that may minimize the expected time to respond to demand (such as, for example, broken equipment). This embodiment may give preference to entities which are more centrally located within the organization in order to maximize the benefits of cross-leveling. This allocation may be based on transit time estimates that may be computed by, for example, a shortest-path algorithm.

An exemplary shortest-path algorithm may compute a preference score M for each company c in the brigade that has available storage, rank the companies based upon the preference score M, select the company with the highest preference score M, allocate one item to the company with the highest preference score M and repeat until all remaining items are allocated or all companies meet their capacity limit. If all of the companies meet their capacity limit then allocate any remaining items to a battalion level supply depot.

There are several score metrics that the present invention may use to compute a preference score M for each company. One of the simplest metrics is based on the expected transit time between companies. For each two companies in the brigade, c₁ and c₂, let L(c₁,c₂) denote the expected transit time between them. Based on this, for each company c₁ the invention may define the metric M(c₁) to be the sum of expected transit times to other companies. Let C be the set of all companies in the brigade. Then

$$M ( {c}_{1} ) = {\sum }_{c 2 ∈ C} L ( {c}_{1} , {c}_{2} ) \qquad ( 7 )$$

A lower preference score, M(c₁), indicates a company, c₁, which is more centrally situated in the battalion and, therefore, is probably in a better position to respond to requests for parts from the other companies in the battalion. Therefore, it makes sense to select the company with the minimum score M to award the next inventory item.

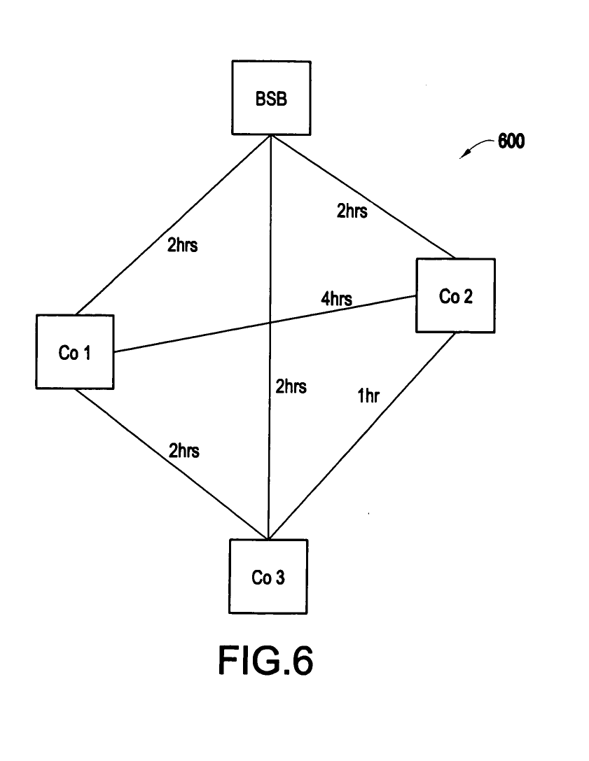

For example, FIG. 6 illustrates a brigade 600, which includes three companies, Co1, Co2, and Co3, and a Brigade Supply Battalion, BSB. An exemplary embodiment of the present invention would select Co3 as having the lowest preference score based upon the above equation (7).

However, while the simple preference score metric M considers transit time, it does not consider the inventory picture. Thus, an exemplary embodiment of the invention may enhance the metric M by defining a metric M₁, as follows:

$${M}_{1} ( p , {c}_{1} ) = {\sum }_{{c}_{2} ∈ C} max \{ 0 , ( \frac{{X}_{{pc}_{1}}}{{w}_{{c}_{1}} {D}_{{pc}_{1}}} - \frac{{X}_{{pc}_{2}}}{{w}_{{c}_{2}} {D}_{{pc}_{2}}} ) L ( {c}_{1} , {c}_{2} ) \} \qquad ( 8 )$$

Where:

M₁ is an expected transit time weighted by the difference in weighted fulfillment ratios.

In general, smaller values for M₁ may be preferred.

An exemplary embodiment of the present invention may also use a second metric M₂ to break ties. M₂ may be defined as the expected transit time weighted by the expected fulfillment ratio as follows:

$${M}_{2} ( p , {c}_{1} ) = {\sum }_{{c}_{2} ∈ C} ( \frac{{X}_{{pc}_{2}}}{{w}_{{c}_{2}} {D}_{{pc}_{2}}} ) L ( {c}_{1} , {c}_{2} ) \qquad ( 9 )$$

Like M₁, smaller values for M₂ may be preferred.

As may be noted, M₁ applies only to companies, while M₂ applies both to companies and to a brigade level supply. They may both help to allocate inventory such that the spare parts are located close to those companies having lower fulfillment ratios.

Moreover, M₁ may be used by an exemplary embodiment of the invention to spread the inventory across the brigade so as to deal with demand uncertainties. This may be achieved via the difference between the expected fulfillment ratios component. Such an inventory allocation as provided by the present invention enables quick replenishment of broken parts.

To deal with numerical instabilities arising from very small relative weights w_{c} or w_{b} assigned to companies or battalions in an operational plan, an exemplary embodiment of the invention may use a threshold value, such as, for example, ε:=0.001. If the relative weight of a military unit is less than the threshold value ε the invention may set the relative weight to ε. In such cases, if the relative weight is a small value, the metric M₁ defined in (8) will evaluate to a large number and as a result the unit will receive a low score which makes it an unlikely candidate for inventory allocation.

Using the above allocations, an exemplary embodiment of the invention may then generate an inventory plan for an entire organization (e.g., brigade) and the entities within that organization (e.g., companies and battalions)

Because allocation of inventory to instantaneously respond to breakages may entail fractional quantities of inventory being assigned to individual units, an embodiment of the present invention may truncate and collect any fractional quantities in the inventory allocation, and may then repeat the process of allocating parts until at most one unit is allocated a fractional quantity in the inventory allocation. This may be of particular significance when the supply of an item is constrained. In such cases, the inventory allocation may end up with fractional values.

Consider the following example: a battalion has four companies, each company has a demand for one repair part. If, in total, only one repair part were available to that battalion, an embodiment of the invention would end up allocating one-quarter of that part to each of the four companies. In order to prevent this, an exemplary embodiment of the present invention may collect all of the fractional quantities and may iterate through the constrained part allocation again to decide the placement of the parts collected from the fractions.

In this manner, the inventory allocation generated by the present invention is always feasible: the total amount of parts delivered to military units is always equal to the amount of parts that is cross-leveled from other military units including the battalion level supply. For example, if company A is scheduled to receive ten parts at a time t, then there are companies other than company A that, in sum, provide the ten parts.

While the invention has been described in terms of several exemplary embodiments, those skilled in the art will recognize that the invention can be practiced with modification.

For example, while the exemplary embodiments described above where described as being useful for a military organization, the present invention is not limited to military applications. Rather, the present invention may generate inventory allocation for any organization which includes a plurality of entities.

Further, one of ordinary skill in the art understands that parts, and/or items, include, for example, supply parts, service parts, repair parts, production parts, non-discrete parts, and the like.

One of ordinary skill in the art also understands that enterprise-wide metrics may include, for example, operational availability, equipment readiness, customer wait time, demand satisfaction, off-the-shelf fill rate, and the like.

Further, it is noted that, Applicant's intent is to encompass equivalents of all claim elements, even if amended later during prosecution.

What is claimed is:

1. A system for optimizing an inventory placement policy for parts within an organization comprising a plurality of mobile entities, the system comprising:
an instant inventory allocator that allocates at least one of said parts to one of the plurality of mobile entities according to a demand within the plurality of mobile entities; and
an inventory allocation output device that generates an output that includes the inventory allocated by said instant inventory allocator.

2. The system of claim 1, wherein said demand comprises a deployment plan over a future planning horizon.

3. The system of claim 1, wherein said demand within at least one of the plurality of mobile entities comprises at least one of a backlog demand and a forecast demand.

4. The system of claim 1, wherein said instant inventory allocator allocates said at least one part based upon a priority weight and a storage capacity of said one of the plurality of mobile entities.

5. The system of claim 1, further comprising:
a response time minimizing allocator that allocates at least one other of said parts to one of the plurality of mobile entities to minimize a response time between entities, wherein said inventory allocation output device generates a report that includes the inventory allocated by said instant inventory allocator and said response time minimizing allocator.

6. The system of claim 5, wherein said response time minimizing allocator allocates said at least one other of said parts based upon a transit time between at least two of said plurality of mobile entities.

7. The system of claim 5, wherein said response time minimizing allocator allocates said at least one other of said parts based upon a plurality of transit times between at least two of said plurality of mobile entities, at least one of which is expected to change location within a period of time.

8. The system of claim 5, wherein said response time minimizing allocator allocates at least one other of said parts to one of the plurality of mobile entities further based upon a storage capacity of said one of the plurality of mobile entities.

9. The system of claim 5, wherein said plurality of mobile entities within said organization comprises at least one of a flat and a hierarchical structure,
wherein said instant inventory allocator allocates said at least one of said parts to one of the plurality of mobile entities based upon said at least one of a flat and a hierarchical structure, and
wherein said response time minimizing allocator allocates said at least one other of said parts to one of the plurality of mobile entities based upon said at least one of a flat and a hierarchical structure.

10. The system of claim 5, wherein said response time minimizing allocator allocates said at least one other of said parts to one of the plurality of mobile entities based upon a weighted fulfillment ratio.

11. A method for optimizing an inventory placement policy for parts within an organization comprising a plurality of mobile entities, the method comprising:
allocating at least one of said parts to one of the plurality of mobile entities according to a demand within the plurality of mobile entities; and
generating a report that is based upon said allocating.

12. The method of claim 11, wherein said demand comprises a deployment plan over a future planning horizon, and wherein said demand within at least one of the plurality of mobile entities comprises at least one of a backlog demand and a forecast demand.

13. The method of claim 11, wherein said allocating said at least one part comprises allocating said at least one part based upon a priority weight and a storage capacity of said one of the plurality of mobile entities.

14. The method of claim 11, further comprising:
allocating at least one other of said parts to one of the plurality of mobile entities to minimize a response time between entities, wherein said generating said output comprises generating a report based upon said allocating of at least one of said parts and upon said allocating of said at least one other of said parts.

15. The method of claim 14, wherein said allocating at least one other of said parts comprises allocating said at least one other of said parts based upon a transit time between at least two of said plurality of mobile entities.

16. The method of claim 14, wherein said allocating at least one other of said parts comprises allocating said at least one other of said parts based upon a plurality of transit times between at least two of said plurality of mobile entities, at least one of which is expected to change location within a period of time.

17. The method of claim 14, wherein said allocating at least one other of said parts comprises allocating said at least one other of said parts to one of the plurality of mobile entities further based upon a storage capacity of said one of the plurality of mobile entities.

18. The method of claim 14, wherein said plurality of mobile entities within said organization comprises at least one of a flat and a hierarchical structure,
wherein said allocating said at least of said parts comprises allocating said at least one of said parts to one of the plurality of mobile entities based upon said at least one of a flat and a hierarchical structure, and
wherein said allocating said at least one other of said parts comprises allocating said at least one other of said parts to one of the plurality of mobile entities based upon said at least one of a flat and a hierarchical structure.

19. A computer-readable storage medium storing instructions for performing the method of claim 11.

20. A system for optimizing an inventory placement policy for parts within an organization comprising a plurality of mobile entities, the system comprising:
means for allocating at least one of said parts to one of the plurality of mobile entities according to a demand within the plurality of mobile entities; and
means for generating a report that based upon said allocating.
